(19) United States
(12) Patent Application Publication
(10) Pub. No.: US 2017/0345129 A1
(43) Pub. Date: Nov. 30, 2017

(54) IN LOOP STITCHING FOR MULTI-CAMERA ARRAYS

(71) Applicant: GoPro, Inc., San Mateo, CA (US)

(72) Inventors: Sandeep Doshi, Sunnyvale, CA (US); Adeel Abbas, Carlsbad, CA (US)

(21) Appl. No.: 15/607,152

(22) Filed: May 26, 2017

Related U.S. Application Data
(60) Provisional application No. 62/342,106, filed on May 26, 2016.

(51) Int. Cl. G06T 3/40; H04N 7/18; H04N 5/232; H04N 13/02; H04N 19/85

(52) U.S. Cl. CPC G06T 3/4038; H04N 13/0239; H04N 19/85; H04N 5/23238; H04N 7/181

(57) ABSTRACT

Methods and apparatus for the stitching of images from a multi-camera array. In one embodiment, stitching is performed for a first image and a second image with an overlapping field of view by: encoding the first image to produce a first encoded image; encoding the second image to produce a second uncompressed encoded image; stitching the first image with the second image by: decoding the first encoded image to produce a decoded first image; storing the decoded first image in memory; accessing, by a stitching engine, the decoded first image from memory; accessing, by the stitching engine, the second uncompressed encoded image; stitching, by the stitching engine, the decoded first image with the accessed second uncompressed encoded image to produce a stitched image; and outputting, by the stitching engine, the stitched image.

### PRIORITY

This application claims the benefit of priority to U.S. Provisional Patent Application Ser. No. 62/342,106 filed May 26, 2016 entitled “In Loop Stitching for Multi-Camera Arrays”, the contents of which being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the disclosure

This disclosure relates to multi-camera arrays and, more specifically, to methods for stitching images captured by a multi-camera array.

### Description of Related Art

Corresponding images captured by multiple cameras in a multi-camera array may be combined (or “stitched”) together to create larger images. The resulting stitched images may include a larger field of view and more image data than each individual image. For example, in typical stitching applications, encoded image/video content is decoded prior to being stitched. However, these stitched images can be computationally inefficient, in particular with respect to memory access (read/write) bandwidth considerations. Generating stitched images using a multi-camera array may be more cost-effective than capturing an image of a similar field of view and image data using a higher-resolution and/or higher-performance camera. However, the process of stitching images may produce stitched images with stitching artifacts at or near the stitch lines, and can require intensive computations, power, time, and storage (memory access) bandwidth.

### SUMMARY

The present disclosure satisfies the foregoing needs by providing, inter alia, methods and apparatus for producing stitched images from multi-camera systems.

In a first aspect, a method for stitching images is disclosed. In one embodiment, the method includes accessing first image captured by a first camera; accessing a second image captured by a second camera, the first image and the second image including portions representative of an overlapping field of view; encoding the first image to produce a first encoded image; encoding the second image to produce a second uncompressed encoded image; stitching the first image with the second image by: decoding the first encoded image to produce a decoded first image; storing the decoded first image in memory; accessing, by a stitching engine, the decoded first image from memory; accessing, by the stitching engine, the second uncompressed encoded image; stitching, by the stitching engine, the decoded first image with the accessed second uncompressed encoded image to produce a stitched image; and outputting, by the stitching engine, the stitched image.

In one variant, the method further includes synchronizing a decoder associated with the decoding of the first encoded image with the stitching engine, the synchronizing configured to reduce memory usage, system latency and computational resources as compared with non-synchronized stitching.

In another variant, the method further includes converting the first image captured by the first camera and converting the second image captured by the second camera from a first imaging format to a second imaging format prior to the encoding of the first image and prior to the encoding of the second image.

In yet another variant, the method further includes scaling down the decoded first image in order to produce a scaled down decoded first image; scaling down the second uncompressed image in order to produce a scaled down second uncompressed image; and stitching the scaled down decoded first image with the scaled down second uncompressed image.

In a second aspect, a computer readable apparatus is disclosed. In one embodiment, the computer readable apparatus includes a non-transitory storage medium having computer-executable instructions stored thereon, the computer-executable instructions being configured to, when executed by one or more processing apparatus, perform one or more portions of the aforementioned methodologies described herein.

In a third aspect, a hardware apparatus is disclosed. In one embodiment, the hardware apparatus is configured to perform one or more portions of the aforementioned methodologies described herein.

In a fourth aspect, a camera system is disclosed. In one embodiment, the camera system includes an image stitching pipeline for use in a multi-camera system, the image stitching pipeline configured to generate stitched image data, the camera system, including: a first image sub-pipeline comprising a first image sensor, a first encoder, a first memory, and a first decoder; a second image sub-pipeline comprising a second image sensor, a second encoder, and a second memory; and an in-loop stitching engine configured to stitch images from the first image sensor and the second image sensor during capture and processing of image data captured by a camera system; where: (i) the first encoder and the second encoder are synchronized; or (ii) the in-loop stitching engine and the first decoder are synchronized, the synchronization being configured to reduce memory usage, system latency and computational resources as compared with non-synchronized image stitching.

In one variant, the first image sub-pipeline and the in-loop stitching engine are contained within a first housing of a first camera.

In another variant, the second image sub-pipeline is contained within the first housing of the first camera.

In yet another variant, the second image sub-pipeline and the in-loop stitching engine is contained within a second housing of a second camera and the first image sub-pipeline is contained within a first housing of a first camera.

In yet another variant, the first image sensor is contained within a first camera, the second image sensor is contained within a second camera; and an image server, where the image server comprises the first and second encoder, the first and second memory, the first decoder and the in-loop stitching engine.

In yet another variant, the in-loop stitching engine enables the stitching of images from the first image sensor and the second image sensor in substantially real-time.

In yet another variant, the first encoder and the second encoder are synchronized and the in-loop stitching engine stitches the images from the first image sensor and the second image sensor via: receipt of a first image captured by the first image sensor; receipt of a second image captured by the second image sensor, the first and the second images having an overlapping field of view; encode the first image and store an encoded uncompressed first image in memory; encode the second image and store an encoded uncompressed second image in the memory; access, by the in-loop stitching engine, of the encoded uncompressed first image; access, by the in-loop stitching engine, of the encoded uncompressed second image; and stitch, by the in-loop stitching engine, the encoded uncompressed first image with the encoded uncompressed second image in order to produce a stitched image.

In yet another variant, the in-loop stitching engine and the first decoder are synchronized and the in-loop stitching engine stitches the images from the first image sensor and the second image sensor via: receipt of a first image captured by the first image sensor; receipt of a second image captured by the second image sensor, the first and the second images having an overlapping field of view; encode the first image and store the encoded first image in memory; encode the second image and store an encoded uncompressed second image in the memory; decode the encoded first image and store the decoded first image in the memory; access, by the in-loop stitching engine, the encoded uncompressed second image; and stitch, by the in-loop stitching engine, the encoded uncompressed second image with the decoded first image in order to produce a stitched image.

In yet another variant, the camera system is further configured to: scale down the decoded first image in order to produce a scaled down decoded first image; scale down the encoded uncompressed second image in order to produce a scaled down uncompressed second image; and stitch the scaled down decoded first image with the scaled down uncompressed second image.

In a fifth aspect, an in-loop stitching engine is disclosed. In one embodiment, the in-loop stitching engine includes: one or more hardware processors that are configured to: access uncompressed imaging data from a first image sub-pipeline; access compressed imaging data from a second image sub-pipeline; decompress the compressed imaging data from the second image sub-pipeline in order to generate decompressed imaging data; and stitch the uncompressed imaging data with the decompressed imaging data.

In one variant, the one or more hardware processors are configured to perform a plurality of different stitching operations of varying image stitching power or varying image stitching quality.

In another variant, a first stitching operation of the plurality of different stitching operations is configured to: identify portions of two or more separately captured images representative of an overlap region; align the identified portions of the two or more separately captured images representative of the overlap region; and average or feather the aligned identified portions of the two or more separately captured images representative of the overlap region in order to generate a stitched image.

In yet another variant, a second stitching operation of the plurality of different stitching operations is configured to: determine a depth of an imaging feature contained within the overlap region associated with the two or more separately captured images; and perform an image warp operation based at least in part on the determined depth of the imaging feature contained within the overlap region associated with the two or more separately captured images; where the image warp operation adjusts the shape and/or size of the imaging feature contained within the overlap region associated with the two or more separately captured images.

In yet another variant, a third stitching operation of the plurality of differing stitching operations is configured to: receive a sequence of frames of a video sequence; and determine the depth of the imaging feature contained within the overlap region associated with the two or more separately captured images based on an analysis of the received sequence of frames of the video sequence.

In yet another variant, an iterative application of one or more of the first stitching operation, the second stitching operation, and the third stitching operation in order to generate a higher quality stitched image as compared with a single performance of the respective first, second, and third stitching operations.

In yet another variant, an interface that enables a selection of one or more of the first stitching operation, the second stitching operation, and the third stitching operation.

Other features and advantages of the present disclosure will immediately be recognized by persons of ordinary skill in the art with reference to the attached drawings and detailed description of exemplary implementations as given below.

### BRIEF DESCRIPTION OF THE DRAWINGS

The disclosed embodiments have other advantages and features which will be more readily apparent from the following detailed description of the invention and the appended claims, when taken in conjunction with the accompanying drawings, in which:

FIG. 1A illustrates a first multi-camera system, according to one embodiment.

FIG. 1B illustrates a second multi-camera system, according to one embodiment.

FIG. 2 illustrates a multi-camera array image stitching environment, according to one embodiment.

FIG. 3 illustrates an image stitching pipeline in a multi-camera system, according to one embodiment.

FIG. 4 is a flow chart illustrating a first process for stitching images in a multi-camera array, according to one embodiment.

FIG. 5 is a flow chart illustrating a second process for stitching images in a multi-camera system, according to one embodiment.

All Figures disclosed herein are © Copyright 2016-2017 GoPro, Inc. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations, but other implementations are possible by way of interchange of, substitution of, or combination with some or all of the described or illustrated elements. Wherever convenient, the same reference numbers will be used throughout the drawings to refer to same or like parts.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Exemplary Multi-Camera Array Configurations

A multi-camera array (or multi-camera system) includes a plurality of cameras, each camera having a distinct field of view. For example, the camera array may include a 2×1 camera array, a 2×2 camera array, a spherical camera array (such that the collective fields of view of each camera in the spherical camera array covers substantially 360 degrees in each dimension), or any other suitable arrangement of cameras. Each camera may have a camera housing structured to at least partially enclose the camera. Alternatively, the camera array may include a camera housing structured to enclose the plurality of cameras. Each camera may include a camera body having a camera lens structured on a front surface of the camera body, various indicators on the front of the surface of the camera body (such as LEDs, displays, and the like), various input mechanisms (such as buttons, switches, and touch-screen mechanisms), and electronics (e.g., imaging electronics, power electronics, etc.) internal to the camera body for capturing images via the camera lens and/or performing other functions. In another embodiment, the camera array includes some or all of the various indicators, various input mechanisms, and electronics and includes the plurality of cameras. A camera housing may include a lens window structured on the front surface of the camera housing and configured to substantially align with the camera lenses of the plurality of cameras, and one or more indicator windows structured on the front surface of the camera housing and configured to substantially align with the camera indicators.

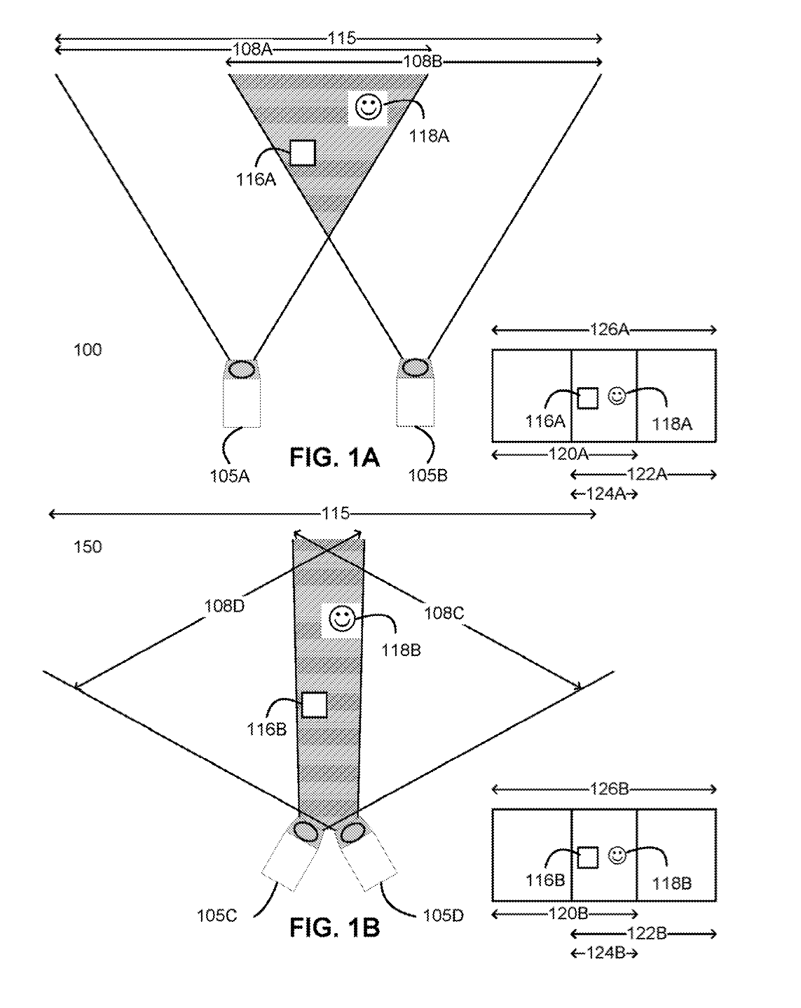

FIGS. 1A and 1B illustrate various multi-camera systems, according to example embodiments. The multi-camera system 100 of FIG. 1A includes two cameras 105A and 105B. The camera 105A is used to capture a left side (e.g., field of view 108A) of a shared field of view 115 as the image 120A and the camera 105B is used to capture a right side (field of view 108B) of the shared field of view 115 as the image 122A. A portion of the field of view 108A of the left camera 105A and a portion of the field of view 108B of the right camera 105B represent a common field of view, as illustrated by the shaded portion of the shared view 115. Within the common field of view are image features 116A and 118A. The images 120A and 122A may be stitched together using an overlap region 124A common to both images, forming stitched image 126A representative of the entire field of view 115.

To combine the image 120A and 122A, a stitching algorithm may be applied to the overlap region 124A to combine the portions of the image 120A and the image 122A representative of the overlap region 124A. Stitching algorithms will be discussed below in greater detail. As stitching algorithms combine two or more portions of image data, stitching may cause various stitching artifacts due to differences between the two or more portions caused by, for instance, object movement during image capture, parallax error, image feature complexity, object distance, image textures, and the like. For instance, the combination of image portions representative of a human face may result in disfigurement of facial features. Similarly, the combination of image portions with particular textures may result in a noticeable visual disruption in an otherwise consistent texture.

In some embodiments, stitching artifacts (such as those caused by image parallax error) may be at least partially mitigated by manipulating the configuration of the cameras within the multi-camera system. The multi-camera system 150 of FIG. 1B includes cameras 105C and 105D. The camera 105C captures a left side (e.g., field of view 108C) of the shared view 115 as the image 120B and the camera 105D captures a right side (e.g., field of view 108D) of the shared view 115 as the image 122B. As with the embodiment of FIG. 1A, the fields of view 108C and 108D include a common field of view represented by the shaded portion of the field of view 115. Within the common field of view are the image features 116B and 118B, which are present within the overlap region 124B of the images 120B and 122B, which are stitched together to form stitched image 126B. In contrast to the embodiment of FIG. 1A, in which the cameras 105A and 105B face the same direction and resulting in an angled common field of view, the cameras 105C and 105D of the embodiment of FIG. 1B face overlapping directions and resulting in a largely parallel common field of view (e.g., the width of the common field of view is substantially the same at multiple distances from the cameras 105C and 105D), reducing parallax error of objects within the common field of view. By reducing parallax error, the embodiment of FIG. 1B may partially reduce stitching artifacts within the stitched image 126B caused by the parallax error (for instance, by aligning the location within the overlap region 124B of each image feature for each of the images 120B and 122B). In some embodiments, the orientation of cameras 105C and 105D is such that the vectors normal to each camera lens of cameras 105C and 105D intersect within the common field of view.

### Exemplary Stitching Algorithms

In some embodiments, the number of stitching artifacts resulting from stitching images (and accordingly, the quality of the stitched image) corresponds to the quality of the stitching algorithm used to stitch the images. Generally, stitching algorithms that require more processing power produce higher quality stitched images (and are referred to as “high quality” and/or “high power” stitching algorithms) than stitching algorithms that require less processing power (referred to as “low quality” and/or “low power” stitching algorithms). Accordingly, image stitching algorithms of varying quality and/or power may be available to an image stitching system, and generally the quality or power of the stitching algorithm selected for use in stitching images is proportional to the quality of the resulting stitched image. For example, two captured images may be encoded independently for a post process off-line “high quality” stitch, while simultaneously (or near simultaneously) decoding a first encoded image and scaling down this decoded first image, scaling down of a second uncompressed image and stitching (and encoding) as a single “low quality” in-line stitched image for display on, for example, a display on a mobile device, a camera, or other devices where a “high quality” stitch may not be necessary.

A first example of an image stitching algorithm may identify portions of each of two or more images representative of an overlap region between the two or more images, may align the identified portions of the images, and may average or feather the image data (such as the pixel color data) of the identified portions of the images to produce a stitched image. In some embodiments, images without overlap regions may be stitched by aligning the edges of the images based on image features in each image and averaging image data across the aligned edges to produce a stitched image.

A second example of an image stitching algorithm that is a higher quality image stitching algorithm than the first example image stitching algorithm may analyze the depth of image features within an overlap region of two or more images. For instance, for an object (such as a vehicle, person, or tree) within a common field of view for two cameras, the depth of the object may be identified and associated with the image feature within each image captured by the two cameras corresponding to the object. Image feature depth may be determined in any suitable way, for instance based on parallax information, based on a known size of the corresponding object and the dimensions of the image feature within the image, and the like.

After identifying a depth associated with an image feature, an image warp operation selected based on the identified depth may be applied to the image feature within each image. The image warp operation adjusts the shape and/or size of the image feature within each image such that the shape and size of the image feature is substantially similar across all images including the image feature. The amount of the adjustment to the shape and size of the image feature (or, the amount of warp applied to the image feature) is inversely proportional to the identified depth of the image feature, such that less warp is applied to image features far away from the cameras than is applied to image features close to the cameras. After an image warp operation is applied to one or more image features within the overlap region, the images may be aligned by aligning the warped image features, and the image data within the overlapping region outside of the aligned image features may be averaged or otherwise combined to produce a stitched image. The stitched image includes the aligned overlap region of the images and portions of each image outside of the overlap region.

A third example of an image stitching algorithm that may be a higher quality image stitching algorithm than the first and second example image stitching algorithms may determine the location of image features by analyzing the location of the image features within video frames temporally adjacent to the images being stitched. For instance, if a first image feature at a first depth suddenly becomes visible in an image within a sequence of images (for instance as a result of an occluding second image feature at a second, closer depth moving to a non-occluding position), the first depth may be identified by analyzing subsequent frames within the sequence of images, and a warp may be applied based on the determined first depth. Note that without analyzing the subsequent frames, the overlapping of the first object and the second object from previous frames may result in a warp operation applied to the first object but based on the second depth of the second object. Accordingly, as the third example image stitching algorithm determines depth information for image features based on an analysis of temporally proximate images within an image series, the third example image stitching algorithm requires more processing power than the second example image stitching algorithm (which determines depth information based only on the image in which an image feature occurs).

In some embodiments, image stitching algorithms may iteratively apply stitching operations that combine and/or smooth image data within an overlap region of two or more images such that the more iterations of stitching operations applied to an overlap region, the better the quality of the resulting stitched image. In such embodiments, applying more iterations of stitching operations requires more processing power, and thus selecting the quality of an image stitching algorithm may correspond to selecting a number of iterations of one or more operations to perform within the image stitching algorithm (where an increase in the number of iterations performed corresponds to an increase in stitching operation quality, and vice versa). Examples of iterative operations may include smoothing operations, image data combination operations (such as averaging pixel data), depth determination operations, operations to determine the composition of image data, image feature alignment operations, resolution and/or texture mapping operations, facial feature alignment operations, warping operations, and the like.

In some embodiments, selecting a quality of an image stitching operation comprises selecting a number of frames before and after a current frame to analyze for depth information or motion information (where an increase in the number of frames before and after a current frame selected for analysis corresponds to an increase in stitching operation quality, and vice versa).

In some embodiments, an overlap region between two or more images is divided in image blocks, and each individual block is aligned, warped, and stitched as described above. In such embodiments, the size of the image blocks in the overlap region is inversely proportional to the quality of stitching algorithm (where small image blocks correspond to higher quality stitching algorithms than larger image blocks), and selecting a quality of an image stitching operation may include selecting an overlap region image block size for use in stitching the images corresponding to the overlap region together. In some embodiments, the resolution of portions of images corresponding to an overlap region between the images is reduced in lower quality image stitching algorithms to simplify the stitching of the images, and the resolution of the portions of images corresponding to the overlap region is maintained in higher quality image stitching algorithms.

In some embodiments, image stitching operations may be associated with preparation operations (or “pre-processing” operations) that may be performed before the image stitching operation in order to expedite the image stitching operation. For instance, image data for each of two images associated with an overlap region between the images may be accessed, stored in local memories or buffers, and/or pre-processed before performing the stitching operation. Examples of pre-processing operations include altering the resolution or scaling of the accessed image data, dividing the accessed image data into blocks, determining the depth of image objects represented by the accessed image data, and the like. In some embodiments, image data from frames before and after the images being stitched may be accessed and/or pre-processed. Pre-processing operations may correspond to particular stitching operations such that particular pre-processing operations are performed before, based on, and in response to a determination to perform a corresponding stitching operation.

It should be noted that when a stitching operation is selected according to the methods described herein, the quality of the selected stitching operation may correspond to the quality of the stitching operations described above. For instance, a low quality stitching operation may correspond to the first example image stitching algorithm, a medium quality stitching operation may correspond to the second example image stitching algorithm, and a high quality stitching operation may correspond to the third example image stitching algorithm. Likewise, a high quality image stitching operation may include more image stitching operation iterations or more frames before and after a current frame selected for analysis than a low quality image stitching operation. Finally, when reference is made to selecting a second “higher quality” image stitching operation than a first image stitching operation, the second image stitching operation may be selected from a set of image stitching operations (such as those described herein) that are higher in quality or power than the first image stitching operation, or the number of iterations, analyzed frames, or other operations performed by the first image stitching operation may be increased, thereby resulting in a second image stitching operation of higher quality than the first image stitching operation.

### Exemplary Multi-Camera Environment

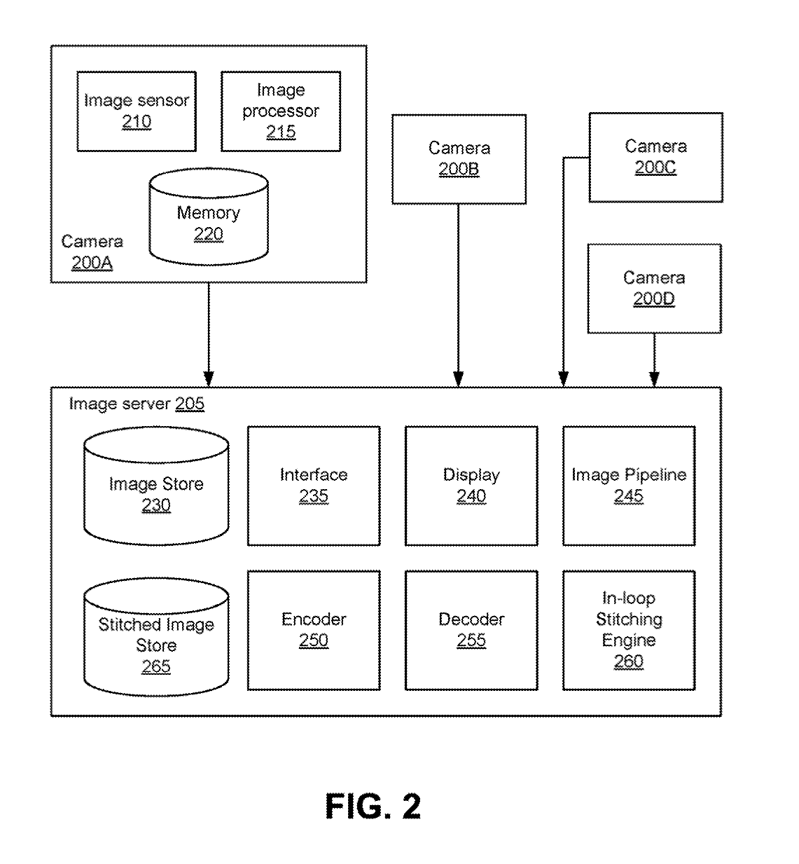

FIG. 2 illustrates a multi-camera array image stitching environment, according to one embodiment. The environment of FIG. 2 includes four cameras, 200A-200D, and an image server 205. It should be noted that in other embodiments, the environment of FIG. 2 may include fewer or more cameras, and may include additional components or systems than those illustrated herein. Further, it should be noted that in some embodiments, the image server 205 may be implemented within a camera 200 itself (such as cameras 200A, 200B, 200C, and/or 200D). For example, in some implementations a single device may include multiple cameras (e.g., cameras 200A-200B, cameras 200A-200D, or other variations having multiple cameras) as well as the image server 205. In some implementations, one of the cameras can receive image data from the other distinct cameras and may stitch the received image data together (for example, by incorporating one or more functionalities of the image server 205) to produce stitched images in real-time during the capture of a sequence of images by the cameras in the array as described herein. Regardless of the implementation chosen, the cameras and the image server will be described separately herein for the purposes of simplicity. The image server 205 may be communicatively coupled to the cameras 200, for instance through a wired connection or a wireless connection, and through one or more networks, such as a local area network, a peer-to-peer network, or the internet. In the embodiment of FIG. 2, two or more of the cameras 200 share one or more overlap regions.

Each camera 200 includes an image sensor 210, an image processor 215, and a memory 220. The image sensor 210 is a hardware component that is configured to capture image data based on light incident upon the image sensor at the time of capture. The captured image data may be stored in the memory 220 without further processing (e.g., as “raw” image data), or may undergo one or more image processing operations by the image processor 215. The image processor 215 is a hardware chip configured to perform image processing operations on captured image data and store the processed image data in the memory 220. The memory 220 is a non-transitory computer-readable storage medium configured to store computer instructions that, when executed, perform one or more of the camera functionality steps as described herein.

Each camera 200 may additionally include other components not illustrated in FIG. 2, such as one or more microcontrollers or processors (e.g., for performing camera functionalities), a lens, a focus controller configured to control the operation and configured of the lens, a synchronization interface configured to synchronize the cameras (for instance, configured to synchronize camera 200A with camera 200B, or to synchronize each of the cameras 200A-200D with the image server 205), one or more microphones, one or more displays (such as a display configured to operate as an electronic viewfinder), one or more I/O ports or interfaces (for instance, enabling the cameras 200 to communicatively couple to and communicate with the image server 205), one or more expansion pack interfaces, and the like.

The image server 205 includes an image storage module 230, an interface module 235, a display 240, an image pipeline module 245, an encoder module 250, a decoder module 255, an in-loop stitching engine 260, and a stitched image store module 265. The image server 205 receives images from the cameras 200 and stores the images in the image storage module 230. In some embodiments, the cameras 200 are synchronized such that each camera captures an image at substantially the same time, and such that each image is timestamped with a time representative of the time at which the image is captured (for instance, within image metadata). In some embodiments, the image server 205 is configured to identify substantially similar timestamps within received images, and is configured to associate and store images with substantially similar timestamps (e.g., within a few seconds, a few milliseconds, a few microseconds, and/or other substantially similar timestamps).

In some embodiments, the image server 205 is configured to process received images to identify overlap regions common to two or more images, for instance by identifying portions of the two or more images having similar or substantially identical image data. In alternative embodiments, the image server 205 knows in advance of the position and orientation of each camera 200, and thereby knows in advance the presence of one or more common overlap regions between images captured by and received from the cameras 200. The image server 205 may associate and store received images with common overlap regions. In such embodiments, the amount of calibration required for identifying the position and orientation of the common overlap regions helps with defining the strength of the stitching required, thereby aiding the selection process with which stitching algorithm from the previous section is adequately applicable in the present given multi-camera scenario.

The image store module 230 is configured to store captured image data received from the camera 200, YUV data from the image pipeline module 245, compressed image data from the encoder module 250, and uncompressed image data from the decoder module 255. In some embodiments, the image store module 230 includes one or more double data rate (DDR) memories, or one or more on-chip buffers. In some embodiments, the image store module 230 has a corresponding memory to store data from each module. The stitched image store module 265 stores stitched image data from the in-loop stitching engine 260. In some embodiments, only one storage module may be used to store all the types of data mentioned above. The image store module 230 and/or the stitched image store module 265 can be local storage (e.g., an in-camera memory) or external memory (e.g., a memory in a computer external to the camera). In the latter embodiment, an encoder module may encode the image data for transmission to the external memory, for example by encoding the YUV image data in the High-definition multimedia interface (HDMI) format and outputting the encoded data in the HDMI output.

The interface module 235 is configured to provide an interface to a user of the image server 205. For instance, the interface module 235 may provide a graphical user interface (GUI) to a user, enabling a user to view one or more images stored by the image server 205 on the display 240, to use the image server 205 as an electronic viewfinder (displaying images representative of views of each camera 200 on the display 240), to select one or more settings for or to configure one or more cameras 200 or the image server 205, and the like. The interface 235 may also provide a communicative interface between the image server 205 and one or more cameras 200, enabling the image server 205 to receive images and other data from the cameras 200, and providing configuration or image capture instructions to the one or more cameras 200. The display 240 is a hardware display configured to display one or more interfaces provided by the interface module 235, to display one or more images stored by the image server 205, or to display information or image data associated with one or more cameras 200.

The image pipeline module 245 is a hardware chip configured to perform image processing operations on raw captured image data and store the processed image data in the image store module 230. The image pipeline module 245 receives captured image data from the cameras 200, processes the received data, and outputs processed image data to the image store module 230.

In some embodiments, the image pipeline module 245 converts the captured image data into YUV image data in a format of the YUV color space. In one embodiment, the captured image data is converted into the YUV image data in the YUV space using a 4:2:0 or 4:2:2 ratio, which indicates that captured image data brightness information is stored at twice the resolution of U-component and V-component image data color information, though other YUV ratios may be used as well (such as a 4:1:1 ratio, a 4:4:4 ratio, and the like). The image pipeline module 245 stores the YUV image data in the image store module 230 for further processing. In some embodiments, the image pipeline module 245 encodes the YUV image data using, for example, H.264 or H.265 encoding or any other suitable coding algorithm. The encoded YUV image data may then be output by the image pipeline module 245 for storage by the image store module 230. In some embodiments, the YUV image data is encoded by the encoder module 250 described below.

In some embodiments, the image pipeline module 245 may process image data normally in a standard mode (for instance, when the received image data is captured at a frame rate and resolution that do not require accelerated image processing), and may process image data in an accelerated mode (for instance, when accelerated image data processing is required or requested). In such embodiments, the image pipeline module 245 can perform a set of processing operations on image data when operating in the standard mode, and can perform a subset of the set of processing operations (or can perform a different set of processing operations) on the image data when operating in the accelerated mode. Alternatively, the image pipeline module 245 may process image data in the accelerated mode regardless of the mode in which the image data was captured.

The encoder module 250 generates compressed image data by encoding the YUV image data generated from the image pipeline module 245 and stores the compressed image data to the image store module 230. The encoder module 250 encodes the YUV image data using one or more lossy or lossless encoding algorithms, e.g., H.264, HEVC and VP9 encoding algorithms, and the encoder module 250 may implement any other suitable image or video encoding algorithms.

In some embodiments, the encoder module 250 includes multiple encoders, each corresponding to a different camera in the multi-camera array and configured to encode the YUV image data independently. The encoder corresponding to each camera may be synchronized such that each encoder encodes the YUV image data at substantially the same time.

The decoder module 255 generates uncompressed image data by decoding the compressed image data generated from the encoder module 250 and stores the uncompressed image data in the image store module 230. In some embodiments, the decode module 255 may decode the compressed data to create the original raw image data. In some embodiments, the decoder module 250 includes multiple decoders, each configured to decode the compressed image data independently.

The in-loop stitching engine 260 is a processing engine (for instance, an image signal processor chip, a special-purpose integrated circuit chip, or any other suitable processor) configured to stitch image data together to produce stitched image data using the compressed image data generated by the encoder module 250 and the uncompressed image data generated by the decoder module 255. As used herein, “in-loop stitching” refers to the stitching of image data during the capture and processing of the image data by a camera system, for instance in real-time or substantially real-time (within the image processing pipeline, or “loop”). Conventional image stitching solutions require two encoded images to be fully decoded, stored in memory, and then accessed by a stitching engine prior to stitching the images together. In contrast, the in-loop stitching engine can receive encoded image data for a first image, and can perform decoding and stitching operations with a second image without requiring the decoded first image to be written to memory. The in-loop stitching engine 260 stores the stitched image data in the stitched image store module 230.

In some embodiments, the in-loop stitching engine 260 is synchronized with the decoder module 255 such that the uncompressed image data is generated by the decoder module 255 in advance and is ready for the in-loop stitching engine to stitch the uncompressed image data with compressed image data generated by the encoder module 250 and received by the in-loop stitching engine. For example, the in-loop stitching engine 260 can access data associated with a first uncompressed image from an image processing pipeline associated with the camera 200A and can access a second compressed image from an image processing pipeline associated with the camera 200B. The in-loop stitching engine 260 then decompresses the second compressed image and stitches the first uncompressed image with the second decompressed image to generate a stitched image representative of both the first image and the second image.

In some embodiments, the in-loop stitching engine 260 may perform a number of different stitching operations of varying image stitching power or quality. The in-loop stitch engine 260 may select one or more stitching operations to perform based on a number of factors, such as the proximity of an image view window (the portion of the one or more images being displayed to and viewed by a user) displayed to a user to an image overlap region, the presence of one or more features within or near an image overlap region, a priority of features within or near an image overlap region, the resolution of image portions within or near an image overlap region, a likelihood that an image stitching operation will produce image artifacts, a depth of image features or objects within or near an image overlap region, and the like. Stitched images may be displayed on the display 240, outputted to one or more cameras 200 or any other external entity, or stored within the stitched image store module 265. The in-loop stitching engine 260 may be a standalone hardware processor, or may be implemented within a larger image processing engine that includes one or more hardware processors.

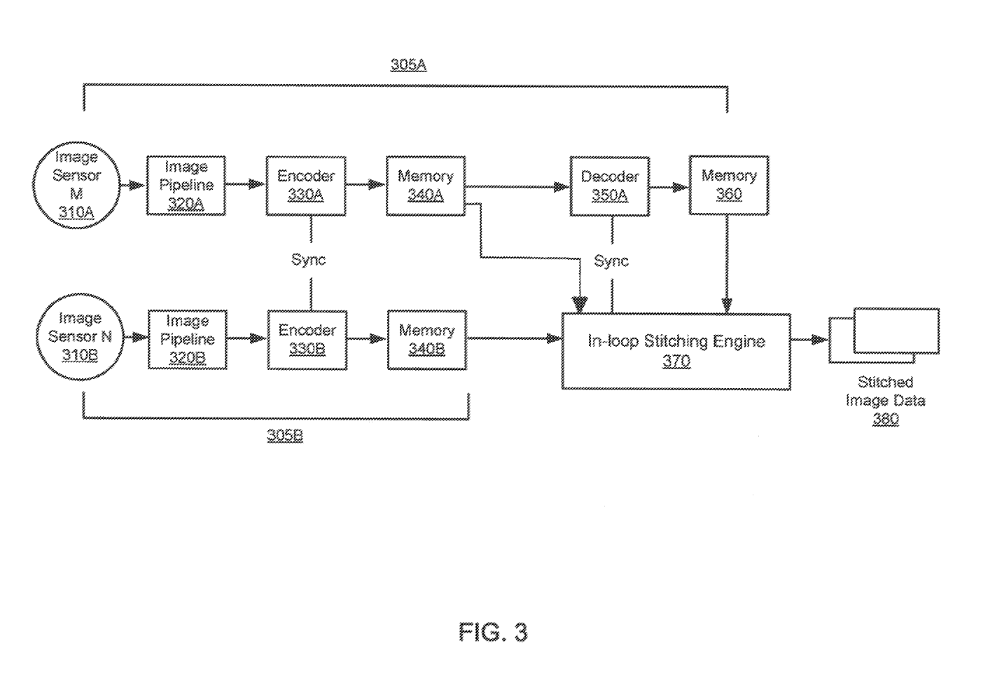

FIG. 3 illustrates an image stitching pipeline in a multi-camera system, according to one embodiment. In some embodiments, the stitching pipeline illustrated in FIG. 3 may be implemented within a standalone camera of a multi-camera array, within a system including multiple cameras (for instance, by a camera within a 2-camera array within one housing or by a stitching system coupled to the cameras) configured to stitch images together in real-time as the images are captured, or within any suitable image stitching system.

For simplicity, two image sub-pipelines are shown in FIG. 3. Sub-pipeline 305A includes image sensor M 310A, pipeline 320A, encoder 330A, memory 340A, decoder 350A, and memory 360. Sub-pipeline 305B includes image sensor N 310B, pipeline 320B, encoder 330B, and memory 340B. Memory 340A and memory 340B may be part of the same memory device, or alternatively may be separate memory devices. The image sensor M and image sensor N capture image data representative of different but overlapping fields of view, for example, the configuration of the two cameras may be similar to FIG. 1A and FIG. 1B. The image pipeline modules 320A and 320B receive the raw image data from respective image sensors M and N; process the raw image to produce YUV image data, and output respective YUV image data for encoding. In some embodiments, the YUV image data from the image pipeline modules 320A and 320B may be stored in memories coupled to the pipeline modules 320A and 320B.

In some implementations, the encoders 330A and 330B synchronously compress (or encode) the YUV data received from the image pipelines 320A and 320B, respectively and store the compressed image data in memories 340A and 340B, respectively. Moreover, by synchronizing the encoders 330A and 330B, one may obviate the need to decode the encoded data stored in, for example, memory 340B. As a brief aside, some encoders (e.g., H.264 encoders) may use previously encoded frames as reference frames for the purpose of encoding a current frame. For example, an encoder may have an inbuilt decoder and each (just encoded) frame is available as, for example, YUV data since this frame may be used as a reference frame for the next frame. Accordingly, encoder 330B may already have this decoded image (e.g., YUV frame data) available. Accordingly, via synchronization of the encoders 330A and 330B, one may obviate the need to provide a separate memory access to retrieve (and decode) previously stored encoded frames, thereby reducing the memory access (read/write) bandwidth and decode computational needs associated with prior stitching techniques. In some implementations, this may obviate the need for decoder 350A and memory 360 (e.g., in implementations where memory 360 is separate and distinct from memory 340A, 340B). In other words, this image data may be directly used for stitching operations. As a result, memory bandwidth may be conserved and/or processing resources reduced by reading it back from encoder 330B as a result of encoders 330A and 330B being synchronized.

In some implementations, the decoder 350A retrieves the compressed image data from the memory 340A, decompresses the compressed image data, and stores the decompressed image data within the memory 360. The in-loop stitching engine 370 may be synchronized with the decoder 350A, receive the decompressed image data from the memory 360, receive the uncompressed post-encoded image data from the memory 340B (or encoder 330B as described supra), and stitches it to the received decompressed image data to produce stitched image data 380. In some implementations, such a variant may be particularly useful in embodiments in which encoder 330A and encoder 330B are not synchronized. Accordingly, by obviating the need to separately retrieve/decode image data from, for example, sub-pipeline 305 via this synchronization between decoder 350A and in-loop stitching engine 370, memory bandwidth may be conserved and/or processing resources reduced as compared with prior stitching techniques. This stitched image data 380 may be entropy compressed and/or may be displayed to a display unit (such as display 240 in FIG. 2). The stitched image data is representative of the image data captured by image sensor M 310A and image sensor N 310B.

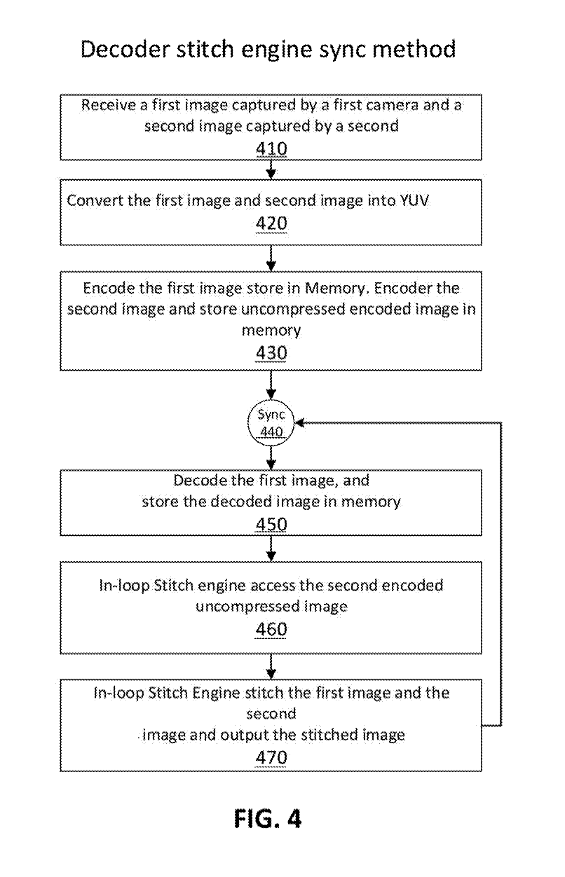

FIG. 4 is a flow chart illustrating a first process for stitching images in a multi-camera array, according to one embodiment. In particular, the process may be suitable for embodiments in which the decoder and stitch engine are synchronized in order to reduce, inter alia, memory access operations (e.g., read/write) as compared with traditional stitching methodologies. As described above, the process may be performed by one camera in a camera array, by a multi-camera system, or by any suitable image stitching system. Additionally, the process may include different or additional steps, or steps performed in different orders than those described herein.

A first image and a second image are received 410 from a multi-camera array (e.g., a first camera and a second camera). The first image and the second image include image data representative of overlapping fields of view. The first image and the second image (for instance, raw image data in a Bayer RGB format) are converted 420 into YUV data. The converted first image is encoded 430 and stored in memory. The converted second image is encoded 430 and the uncompressed encoded second image is stored in memory.

In some implementations, when a decision is made to stitch the images together (for instance, in response to a request from a user of the multi-camera array), the decoder 350A and in-loop stitch engine 370 are synchronized 440. In other variants, the decoder 350A and in-loop stitch engine 370 may remain synchronized 440 without necessitating that a decision be made (e.g., in response to a setting by the multi-camera array to automatically and in real-time stitch captured images together).

The first image may be decoded 450 by decoder 350A, and the decoded first image may be stored in memory 360. The in-loop stitch engine 370 may access 460 the second uncompressed image. The in-loop stitching engine 370 may then stitch 470 the decoded first image and the second encoded uncompressed image and output the stitched image 380. This stitched image data 380 may be entropy compressed and/or may be displayed to a display unit (such as display 240 in FIG. 2).

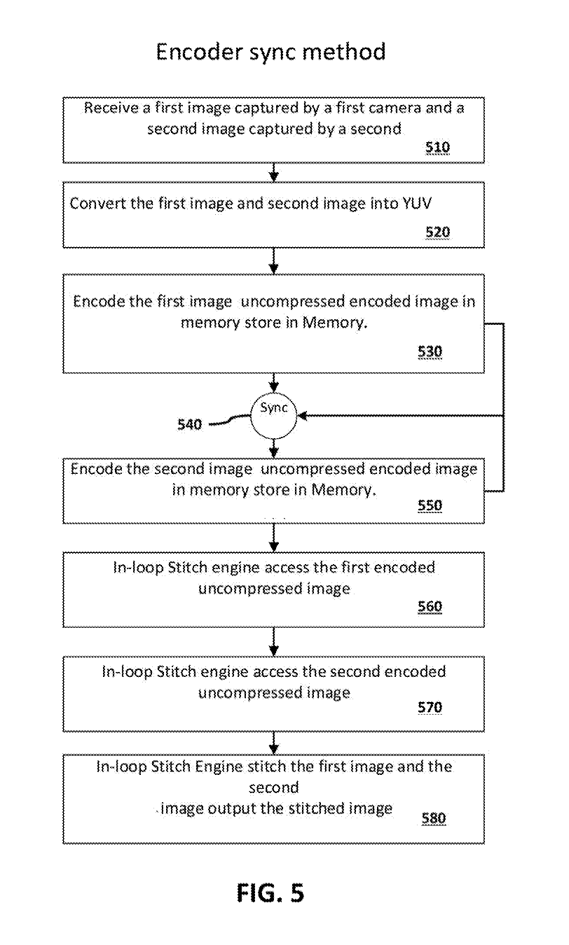

FIG. 5 is a flow chart illustrating a second process for stitching images in a multi-camera array, according to one embodiment. In particular, the process may be suitable for embodiments in which the encoders 330A, 330B are synchronized in order to reduce, inter alia, memory access operations (e.g., read/write) as compared with traditional stitching methodologies. As described above, the process may be performed by one camera in a camera array, by a multi-camera system, or by any suitable image stitching system. Additionally, the process may include different or additional steps, or steps performed in different orders than those described herein.

A first image and a second image are received 510 from a multi-camera array (e.g., a first camera and a second camera). The first image and the second image include image data representative of overlapping fields of view. The first image and the second image (for instance, raw image data in a Bayer RGB format) are converted 520 into YUV data. The converted first image is encoded 530 and the uncompressed encoded first image is stored in memory.

In some implementations, when a decision is made to stitch the images together (for instance, in response to a request from a user of the multi-camera array), the encoders 330A, 330B are synchronized 540. In other variants, the encoders 330A, 330B may remain synchronized 540 without necessitating that a decision be made (e.g., in response to a setting by the multi-camera array to automatically and in real-time stitch captured images together).

The converted second image is encoded 550 and the uncompressed encoded second image is stored in memory. The in-loop stitch engine 370 may then access 560 the first encoded uncompressed image. The in-loop stitch engine 370 may also access 570 the second uncompressed image. The in-loop stitch engine may stitch 580 the first encoded uncompressed image and the second encoded uncompressed image in order to create a stitched image 380. This stitched image data 380 may be entropy compressed and/or may be displayed to a display unit (such as display 240 in FIG. 2).

The stitching engine and methodologies described herein may beneficially reduce the total number of operations and memory read/write bandwidth required in order to stitch two images together. For example, conventional systems might require both images to be fully decoded prior to stitching the images together. This requires at least two decode operations and two read/writes to/from memory for the decoded images. In contrast, the system described herein may require only one of the two images to be fully decoded before being received by the stitch engine. By enabling the stitch engine to receive an encoded image and decode the encoded image prior to stitching it to a received decoded image, the encoded image does not have to be decoded and stored to memory prior to being received by the stitching engine.

In some implementations, one or more portions of the in-loop stitching engine may be embodied within one or more computer-executable instructions stored within a computer readable apparatus having a non-transitory storage medium, the one or more computer-executable instructions, when executed by a processing apparatus, are configured to perform one or more portions of the methodologies described herein.

### Additional Configuration Considerations

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A method for stitching images, comprising:
accessing first image captured by a first camera;
accessing a second image captured by a second camera, the first image and the second image including portions representative of an overlapping field of view;
encoding the first image to produce a first encoded image;
encoding the second image to produce a second uncompressed encoded image;
stitching the first image with the second image by:
decoding the first encoded image to produce a decoded first image;
storing the decoded first image in memory;
accessing, by a stitching engine, the decoded first image from memory;
accessing, by the stitching engine, the second uncompressed encoded image;
stitching, by the stitching engine, the decoded first image with the accessed second uncompressed encoded image to produce a stitched image; and
outputting, by the stitching engine, the stitched image.

2. The method of claim 1, further comprises synchronizing a decoder associated with the decoding of the first encoded image with the stitching engine, the synchronizing configured to reduce memory usage, system latency and computational resources as compared with non-synchronized stitching.

3. The method of claim 2, further comprising converting the first image captured by the first camera and converting the second image captured by the second camera from a first imaging format to a second imaging format prior to the encoding of the first image and prior to the encoding of the second image.

4. The method of claim 3, further comprising:
scaling down the decoded first image in order to produce a scaled down decoded first image;
scaling down the second uncompressed image in order to produce a scaled down second uncompressed image; and
stitching the scaled down decoded first image with the scaled down second uncompressed image.

5. A camera system comprising an image stitching pipeline for use in a multi-camera system, the image stitching pipeline configured to generate stitched image data, the camera system, comprising:
a first image sub-pipeline comprising a first image sensor, a first encoder, a first memory, and a first decoder;
a second image sub-pipeline comprising a second image sensor, a second encoder, and a second memory; and
an in-loop stitching engine configured to stitch images from the first image sensor and the second image sensor during capture and processing of image data captured by a camera system;
wherein: (i) the first encoder and the second encoder are synchronized; or (ii) the in-loop stitching engine and the first decoder are synchronized, the synchronization being configured to reduce memory usage, system latency and computational resources as compared with non-synchronized image stitching.

6. The camera system of claim 5, wherein the first image sub-pipeline and the in-loop stitching engine are contained within a first housing of a first camera.

7. The camera system of claim 6, wherein the second image sub-pipeline is contained within the first housing of the first camera.

8. The camera system of claim 5, wherein the second image sub-pipeline and the in-loop stitching engine is contained within a second housing of a second camera and the first image sub-pipeline is contained within a first housing of a first camera.

9. The camera system of claim 5, wherein the first image sensor is contained within a first camera, the second image sensor is contained within a second camera; and
an image server, where the image server comprises the first and second encoder, the first and second memory, the first decoder and the in-loop stitching engine.

10. The camera system of claim 5, wherein the in-loop stitching engine enables the stitching of images from the first image sensor and the second image sensor in substantially real-time.

11. The camera system of claim 5, wherein the first encoder and the second encoder are synchronized and the in-loop stitching engine stitches the images from the first image sensor and the second image sensor via:
receipt of a first image captured by the first image sensor;
receipt of a second image captured by the second image sensor, the first and the second images having an overlapping field of view;
encode the first image and store an encoded uncompressed first image in memory;
encode the second image and store an encoded uncompressed second image in the memory;
access, by the in-loop stitching engine, of the encoded uncompressed first image;
access, by the in-loop stitching engine, of the encoded uncompressed second image; and
stitch, by the in-loop stitching engine, the encoded uncompressed first image with the encoded uncompressed second image in order to produce a stitched image.

12. The camera system of claim 5, wherein the in-loop stitching engine and the first decoder are synchronized and the in-loop stitching engine stitches the images from the first image sensor and the second image sensor via:
receipt of a first image captured by the first image sensor;
receipt of a second image captured by the second image sensor, the first and the second images having an overlapping field of view;
encode the first image and store the encoded first image in memory;
encode the second image and store an encoded uncompressed second image in the memory;
decode the encoded first image and store the decoded first image in the memory;
access, by the in-loop stitching engine, the encoded uncompressed second image; and
stitch, by the in-loop stitching engine, the encoded uncompressed second image with the decoded first image in order to produce a stitched image.

13. The camera system of claim 12, wherein the camera system is further configured to:
scale down the decoded first image in order to produce a scaled down decoded first image;
scale down the encoded uncompressed second image in order to produce a scaled down uncompressed second image; and
stitch the scaled down decoded first image with the scaled down uncompressed second image.

14. An in-loop stitching engine, the in-loop stitching engine comprising:
one or more hardware processors that are configured to:
access uncompressed imaging data from a first image sub-pipeline;
access compressed imaging data from a second image sub-pipeline;
decompress the compressed imaging data from the second image sub-pipeline in order to generate decompressed imaging data; and
stitch the uncompressed imaging data with the decompressed imaging data.

15. The in-loop stitching engine of claim 14, wherein the one or more hardware processors are configured to perform a plurality of different stitching operations of varying image stitching power or varying image stitching quality.

16. The in-loop stitching engine of claim 15, wherein a first stitching operation of the plurality of different stitching operations is configured to:
identify portions of two or more separately captured images representative of an overlap region;
align the identified portions of the two or more separately captured images representative of the overlap region; and
average or feather the aligned identified portions of the two or more separately captured images representative of the overlap region in order to generate a stitched image.

17. The in-loop stitching engine of claim 16, wherein a second stitching operation of the plurality of different stitching operations is configured to:
determine a depth of an imaging feature contained within the overlap region associated with the two or more separately captured images; and
perform an image warp operation based at least in part on the determined depth of the imaging feature contained within the overlap region associated with the two or more separately captured images;
wherein the image warp operation adjusts the shape and/or size of the imaging feature contained within the overlap region associated with the two or more separately captured images.

18. The in-loop stitching engine of claim 17, wherein a third stitching operation of the plurality of differing stitching operations is configured to:
receive a sequence of frames of a video sequence; and
determine the depth of the imaging feature contained within the overlap region associated with the two or more separately captured images based on an analysis of the received sequence of frames of the video sequence.

19. The in-loop stitching engine of claim 18, further comprising an iterative application of one or more of the first stitching operation, the second stitching operation, and the third stitching operation in order to generate a higher quality stitched image as compared with a single performance of the respective first, second, and third stitching operations.

20. The in-loop stitching engine of claim 18, further comprising an interface that enables a selection of one or more of the first stitching operation, the second stitching operation, and the third stitching operation.
